(19) United States
(12) Patent Application Publication
(10) Pub. No.: US 2008/0062102 A1
(43) Pub. Date: Mar. 13, 2008

(54) LIQUID CRYSTAL DISPLAY DEVICE AND CONTROL METHOD USED IN SAME

(75) Inventors: TSUYOSHI ICHIRAKU, Kanagawa (JP); NORIYUKI TAKAGI, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC LCD Technologies, Ltd., Kanagawa (JP)

(21) Appl. No.: 11/845,314

(22) Filed: Aug. 27, 2007

(30) Foreign Application Priority Data
Sep. 11, 2006 (JP) 2006-246180

(51) Int. Cl. G09G 3/36; G06F 5/00

(52) U.S. Cl. 345/89; 345/211

(57) ABSTRACT

A liquid crystal display device employing an AC driving method is provided which is capable of minimizing a period of time during which a difference in magnitude between a positive voltage and a negative voltage relative to an intermediate potential occurs in gray-level reference voltages making up AC driving voltages when AC voltages are changed during operations of the liquid crystal display device by selecting an optimized order of outputting the gray-level reference voltages generated by a sequential switching method. An output switching control section is provided in a gray-level reference voltage generating section which outputs, at a time of changing the gray-level reference voltages during operations of the device, the gray-level reference voltage to a source driver in an order being different from an order of having received the gray-level reference voltage input from a same output voltage setting section after being sequentially switched.

### INCORPORATION BY REFERENCE

This application is based upon and claims the benefit of priority from Japanese Patent Application No. 2006-246180, filed on Sep. 11, 2006, the disclosure of which is incorporated herein in its entirely by reference.

### BACKGROUND OF THE INVENTION

1. Field of the Invention

The present invention relates to a liquid crystal display (hereinafter, may be simply referred to as LCD) device employing an AC (Alternating Current) driving method which is capable of suppressing an increase in the number of components and reducing a decrease in a degradation of quality of display, and a method of controlling the LCD device.

2. Description of the Related Art

FIG. 8 is a diagram showing basic configurations of a conventional LCD device, which chiefly includes a displaying section made up of an LCD panel 1, a source driver IC (Integrated Circuit) 2, and a gate driver IC 3, a gray-level reference voltage generating section 4, a power supply section 5, and a control section 6. In the LCD panel 1. Each pixel formed at each intersection point of each of a plurality of data lines arranged in a vertical direction and each of a plurality of address lines arranged in a horizontal direction is driven according to a gray-level reference voltage to display images corresponding to input signals.

The source driver IC 2 generates a pixel writing voltage, according to control by the control section 6, using a gray level reference voltage fed from the gray-level reference voltage generating section 4 and a voltage fed from the power supply section 5 and applies the generated pixel writing voltage to each pixel driving transistor in each pixel on pixel strings. The gate driver IC 3 drives a pixel driving transistor for each pixel on pixel strings according to control by the control section 6 by using a voltage fed from the power supply section 5. The gray-level reference voltage generating section 4 generates a gray-level reference voltage, according to external control signals to control switching timing and to designate an output voltage, and supplies the generated gray-level reference voltage to the source driver IC 2.

The power supply section 5 supplies logic supply power to drive each IC chip making up the source driver IC 2 and supply power required to apply a voltage to a source side of each pixel driving transistor formed in each pixel on the pixel strings to the source driver IC 2 and also feeds logic supply power to drive each IC chip making up the gate driver IC 3 and a voltage to turn off a gate of each pixel driving transistor to the gate driver IC 3. The control section 6 supplies information about a position of each data line and a voltage required to generate a pixel writing voltage of each driving transistor formed in each pixel column to the source driver IC 2 and information about a position of each address line and a voltage required to control a gate of each driving transistor formed in each pixel on the pixel strings to the gate driver IC 3.

In the LCD device, in order to determine and set a desired optical γ (gamma) characteristic for the LCD panel 1, ten to twenty gray-level reference voltages are required ordinarily. An optimum value of the gray-level reference voltage varies depending on ambient temperature or a like. There is one type of the gray-level voltage generating circuit in which, by giving a ratio of an output gray-level reference voltage to a reference voltage to be fed from a power supply section, as digital data, from outside, a desired gray-level reference voltage made up of analog values is generated according to the ratio during operations of the LCD device. In the case of this type of the gray-level voltage generating circuit, to generate an output gray-level reference voltage made up of analog values based on digital data, a digital-to-analog (D/A) converter is provided. Also, there are two types of output switching circuits to generate a plurality of gray-level reference voltages in the above gray-level voltage generating circuit, one being a type of a circuit adapted to individually generate an output gray-level reference voltage by using a plurality of D/A converters and the other being a type of a circuit adapted to generate a plurality of gray-level reference voltages by switching one D/A converter sequentially.

FIG. 9 is a diagram showing one example of configurations of circuits to be used when all outputs of gray-level reference voltages to be applied to the source driver IC 2 are generated by using each of different D/A converters which are mounted in a gray-level reference voltage generating section and the number of D/A converters is the same as that of gray-level reference voltage outputs.

In FIG. 9, the gray-level reference voltage generating section 4a includes a gray-level voltage setting section 21 and digital-analog converters 22₀, 22₁, . . . , 22ₙ, 22ₙ₊₁, . . . , 22ₓ₋₁, and 22ₓ. The gray-level voltage setting section 21 sets, according to external control signals, digital data corresponding to each of a plurality of gray-level reference voltage values to be output to the source driver IC 2. The digital-analog converters 22₀, 22₁, . . . , 22ₙ, 22ₙ₊₁, . . . , 22ₓ₋₁, 22ₓ generate, in one operation, all gray-level reference voltage outputs V₀, V₁, . . . , Vₙ, Vₙ₊₁, . . . , Vₓ₋₁, and Vₓ according to analog values obtained by carrying out digital-analog conversion of each digital data output from the gray-level voltage setting section 21 by using a reference voltage fed from the power supply section 5 and then supplies the generated outputs to the source driver IC 2.

The circuit configuration as shown in FIG. 9 presents problems in that, in order to generate all outputs of gray-level reference voltages, the digital-analog converters being the same in number as outputs of gray-level reference voltages are required, thus causing an increased number of component parts, complicated manufacturing processes of the LCD device, and a rise in costs and/or high failure rates caused by an increase in component count.

FIG. 10 is a diagram showing one example of configurations of a circuit to be used when a plurality of gray-level reference voltages is generated by sequentially switching voltage outputs one by one by using the same circuit and, in this case, only one digital-analog converter is provided. A gray-level reference voltage generating section 4b is made up of an output voltage setting section 7 and a switching unit 8. The output voltage setting section 7 sequentially sets each of gray-level reference voltage outputs V₀, V₁, . . . , Vₙ, Vₙ₊₁, . . . , Vₓ₋₁, and Vₓ to be fed to each pixel of pixel strings. The switching unit 8 sequentially switches each of the gray-level reference voltages generated by the output voltage setting section 7 in a specified order and feeds each of the switched voltage to the source driver IC 2.

The output voltage setting section 7 has a gray-level voltage setting section 9 and a digital-analog converter 10. The gray-level voltage setting section 9 sets, according to external control signals, a gray-level voltage made up of digital values corresponding to each pixel of the pixel strings. The digital-analog converter 10 generates the gray-level reference voltages V₀, V₁, . . . , Vₙ, Vₙ₊₁, . . . , Vₓ₋₁, Vₓ according to analog values obtained by carrying out digital-analog conversion of a gray-level voltage made up of digital values by using the reference voltage output from the power supply section 5.

FIG. 11 is a timing chart explaining changes of gray-level reference voltages applied when a plurality of gray-level reference voltages is generated by being sequentially switched one by one by using the same circuit. It is now assumed in the example shown in FIG. 11 that each of the gray-level reference voltages having a subscript such as V₀, V₁, . . . , Vₙ, Vₙ₊₁, . . . , Vₓ₋₁, and Vₓ before being changed is represented as a voltage “VA” and each of the voltages after being changed is represented as a voltage “VB” and that, each of the gray-level reference voltages is changed from VA₀ to VB₀, from VA₁ to VB₁, from VAₙ to VBₙ, from VAₙ₊₁ to VBₙ₊₁, from VAₓ₋₁ to VBₓ₋₁ and from VAₓ to VBₓ, an AC driving voltage made up of VA₀ and VAₓ is referred to as a voltage “A” and an AC driving voltage made up of VB₀ and VBₓ is referred to as a voltage “G”. In this case, during a period “T1” from a time when transition from VA₀ to VB₀ starts to a time when transition from VAₓ to VBₓ ends, an AC driving voltage “D” made up of VB₀ and VAₓ is applied to the source driver IC 2.

Similarly, if it is assumed that an AC driving voltage made up of VA₁ and VAₓ₋₁ is referred to as a voltage “B” and that an AC driving voltage made up of VB₁ and VBₓ₋₁ is referred to as a voltage “H”, during a period “T2” from a time when transition from VA₁ to VB₁ starts to a time when transition from VAₓ₋₁ to VBₓ₋₁ ends, an AC driving voltage “E” is applied to the source driver IC. Moreover, if it is assumed that an AC driving voltage made up of VAₙ and VAₙ₊₁ is referred to as “C” and an AC driving voltage made up of VBₙ and VBₙ₊₁ is referred to as “I”, during a period “T3” from a time when transition from VAₙ to VBₙ starts to a time when transition from VAₙ₊₁ to VBₙ₊₁ ends, an AC driving voltage “F” made up of VBₙ and VAₙ₊₁ is applied to the source driver IC 2.

The method in which a plurality of gray-level reference voltages is generated by being sequentially switched one by one by using the same circuit shown in FIG. 10 has an advantage in that the required number of the digital-analog converters is only one, however, as shown in FIG. 11, due to the reason that the period T1>period T2>period T3, nonuniformity in magnitude between a positive voltage and a negative voltage occurs in the gray-level reference voltage making up the AC driving voltage, which causes a problem of the degradation of display quality.

To solve this problem, it is necessary that, by making it possible to change the order of outputting the gray-level reference voltages to be applied when being changed from VA₀ to VB₀, from VA₁ to VB₁, from VAₙ to VBₙ, from VAₙ₊₁ to VBₙ₊₁, VAₓ₋₁ to VBₓ₋₁, and from VAₓ to VBₓ, to the order of, for example, V₀→Vₓ, . . . , V₁→Vₓ₋₁, . . . , Vₙ→Vₙ₊₁, the period of time during which voltages being nonuniform relative to an optimized intermediate potential (Vcom) are applied at the application of each of the AC driving voltages “A”, “B”, and “C” is minimized. However, a means being able to achieve this has not been realized yet.

The intermediate voltage “Vcom” is defined as “being optimized” when, with a difference between the VA₀ and VAₓ being, for example, “A”, each of a difference between VA₀ and Vcom and difference between Vcom and VAₓ is set to be A/2. Also, the intermediate voltage “Vcom” is defined as “being optimized” when, with a difference between the VA₁ and VAₓ₋₁ being, for example, “B”, each of a difference between VA₁ and Vcom and a difference between Vcom and VAₓ₋₁ is set to be B/2. Moreover, the intermediate voltage “Vcom” is defined as “being optimized” when, with a difference between the VAₙ and VAₙ₊₁ being, for example, “C”, each of a difference between VAₙ and Vcom and a difference between Vcom and VAₙ₊₁ is set to be B/2.

Furthermore, even after the gray-level reference voltage is changed, the intermediate voltage “Vcom” is defined as “being optimized” when, with a difference between the VB₀ and VBₓ being, for example, “G”, each of a difference between VBₓ and Vcom and a difference between Vcom and VBₓ is set to be G/2. Also, even after the gray-level reference voltage is changed, the intermediate voltage “Vcom” is defined as “being optimized” when, with a difference between the VB₁ and VBₓ₋₁ being, for example, “H”, each of a difference between VB₁ and Vcom and a difference between Vcom and VBₓ₋₁ is set to be H/2. Moreover, even after the gray-level reference voltage is changed, the intermediate voltage “Vcom” is defined as “being optimized” when, with a difference between the VBₙ and VBₙ₋₁ being, for example, “I”, each of a difference between VBₙ and Vcom and a difference between Vcom and VBₙ₋₁ is set to be I/2.

Then, as shown in FIG. 11, the time of continuation of states in which a sum of the difference (G/2) and the difference (A/2) becomes the voltage “D” in the process during which the gray-level reference voltage is changed from VA₀ to VB₀ and from VAₓ to VBₓ and in which a sum of the difference (H/2) and the difference (B/2) becomes the voltage “E” in the process during which the gray-level reference voltage is changed from VA₁ to VB₁ and from VAₓ₋₁ to VBₓ₋₁ and in which a sum of the difference (I/2) and the difference (C/2) becomes the voltage “F” in the process during which the gray-level reference voltage is changed from VA₁ to VB₁ and from VAₓ₋₁ to VBₓ₋₁ becomes the time when a voltage being nonuniform relative to the intermediate potential (Vcom) is applied.

As described above, in order to prevent the degradation of display quality caused by the application of an AC driving voltage having the nonuniformity in magnitude between its positive voltage and negative voltage during operations of switching of a gray-level voltage, the minimization of the period of time during which a voltage having the nonuniformity in magnitude between the positive and negative voltages is applied is required.

In Japanese Patent Application Laid-open No. 2002-258816 (FIGS. 1 and 2, [0016] to [0019] and [0035], an LCD device is disclosed which is capable of achieving miniaturization, reduction in costs, and ease of calibrating operations, which is configured to apply image signals to a liquid crystal panel using an image data signal, and which also provides a control method of a gray-level reference voltage in a liquid crystal driving circuit, however, there is provided no description of minimizing the period of time during which voltages being nonuniform relative to an optimized intermediate voltage (Vcom) are applied to driving circuits by outputting a gray-level reference voltage in the order being different from the order of having received the gray-level reference voltage by using a switching unit when a plurality of AC driving voltages is input to a liquid crystal driving circuit after being sequentially switched.

Also, in Japanese Patent Application Laid-open No. 2004-279567 (FIG. 1, [0034] and [0035]), a driving method and driving circuit are disclosed which are capable of preventing discontinuation of gray-levels to drive an electrical/optical device, however, there is provided no description of minimizing the period of time during which voltages being nonuniform relative to an optimized intermediate voltage (Vcom) are applied to the driving circuit by outputting gray-level reference voltages in the order being different from the order of having received the gray-level reference voltages by using a switching unit when a plurality of AC driving voltages is applied to the electrical/optical device after being sequentially switched.

Also, in Japanese Patent Application Laid-open No. 2004-361709 (FIG. 6), a liquid crystal driving method is disclosed which is capable of realizing low power consumption when the LCD panel is driven by an AC voltage, however, there is provided no description of minimizing the period of time during which voltages being non-uniform relative to an optimized intermediate voltage (Vcom) are applied to the LCD panel by outputting gray-level reference voltages in the order being different from the order of having received the gray-level reference voltages by using a switching unit when a plurality of AC driving voltages is applied to the LCD panel after being sequentially switched.

Also, in Japanese Patent Application Laid-open No. 2005-049418 (FIGS. 8 and 9, [0002] to [0006]), a LCD device is disclosed which is capable of displaying images well by removing variations in γ (gamma) characteristics, however, there is provided no description of minimizing the period of time during which voltages being non-uniform relative to an optimized intermediate voltage (Vcom) are applied to the LCD device by outputting gray-level reference voltages in the order being different from the order of having received the gray-level reference voltages by using a switching unit when a plurality of AC driving voltages is applied to the LCD device after being sequentially switched.

In Japanese Patent Application Laid-open No. 2006-048083, an LCD device is provided which is capable of reducing a mounting area by placing a liquid crystal driver on one side of the liquid crystal panel and capable of displaying images of high quality by applying an inversion driving method to every column and of reducing a circuit scale of a power supply circuit by letting a DC (direct current)−AC (alternating current) converting circuit for a reference voltage of the liquid crystal driving be embedded, however, there is provided no description of minimizing the period of time during which voltages being non-uniform relative to an optimized intermediate voltage (Vcom) are applied to the LCD device by outputting gray-level reference voltages in the order being different from the order of having received the gray-level reference voltages by using a switching unit when a plurality of AC driving voltages is applied to the LCD device after being sequentially switched.

However, these conventional technologies have problems. That is, in the conventional LCD device employing an AC driving method, when a gray-level reference voltage is generated by sequentially switching, by using an output switching control section, an output from the same output voltage setting section, a period of time during which a difference between positive and negative voltages is not kept at a constant level relative to an intermediate potential (Vcom) in the gray-level reference voltage making up the AC driving voltage occurs when the order of outputting a plurality of gray-level reference voltages is switched (changed) from a high-voltage side to a low-voltage side and from the low-voltage side to the high-voltage side for every frame and, as a result, afterimages, flicker phenomena, luminance change phenomena or a like occur, thus causing the degradation of display quality. By changing a sequence of outputting a gray-level reference voltage, an AC driving voltage is changed during operations of the LCD device employing the AC driving method and, therefore, it is necessary that, by minimizing the period of time during which a difference between positive and negative voltages relative to an optimized intermediate potential (Vcom) occurs in the gray-level reference voltage making up an AC driving voltage, the abnormality in displaying such as an afterimage, flicker phenomenon, luminance change phenomenon or a like is suppressed.

### SUMMARY OF THE INVENTION

In view of the above, it is an object of the present invention to provide an LCD device employing an AC method which is capable of minimizing a period of time during which a difference between a positive voltage and a negative voltage relative to an optimized intermediate potential (Vcom) occurs in a gray-level reference voltage making up an AC driving voltage when the gray-level reference voltage is changed during operations of the LCD device, by generating a gray-level reference voltage according to a sequential switching method and then changing an order of outputting the gray-level reference voltage to its optimum order of outputting, thereby enabling the suppression of display abnormality such as an afterimage, flicker phenomenon, luminance change phenomenon, or a like, and the method of controlling the LCD device.

According to a first aspect of the present invention, there is provided an LCD device employing an AC driving method including:

an output switching control section provided in a gray-level reference voltage generating unit to output a gray-level reference voltage to a source driver in an order being different from an order of having received the gray-level reference voltage from a same output voltage setting section after being sequentially switched, wherein the output switching control section exerts control, at a time of changing an order of outputting the gray-level reference voltage during operations of the LCD device, so as to minimize a period of time during which a difference in magnitude between a positive voltage and a negative voltage relative to an optimized intermediate potential occurs in the gray-level reference voltage making up an AC driving voltage to be input to the source driver.

According to a second aspect of the present invention, there is provided an LCD device employing an AC driving method including:

an output switching control section provided between an output voltage setting section and a source driver, wherein the output switching control section exerts control so as to supply a gray-level reference voltage input after being sequentially switched to the source driver in an order being different from an order of having received the gray-level reference voltage and so as to minimize, at a time of changing an order of outputting the gray-level reference voltage during operations of the LCD device, a period of time during which a difference in magnitude between a positive voltage and a negative voltage relative to an optimized intermediate potential occurs in the gray-level reference voltage making up an AC driving voltage to be input to the source driver.

In the foregoing first and second aspects, a preferable mode is one wherein the output switching control section includes a switching unit control section to control so that the gray-level reference voltage is output in a specified sequence in an order being different from an order in which the gray-level reference voltage has been input and a switching unit to make a gray-level reference voltage fed from the output voltage setting unit be output to the source driver according to control of the output switching control section in an order being different from an order in which the gray-level reference voltage has been input.

Also, a preferable mode is one that wherein includes a supply power monitoring circuit to monitor a state of supply power to be fed to the LCD device and to output control information when the LCD device is driven and wherein the output switching control section is configured not to change, at a starting time of operations of the LCD device, an order of outputting a gray-level reference voltage fed from the output voltage setting unit and to output, at a driving time of the LCD device, according to the control information, the gray-level reference voltage fed from the output voltage setting unit in an order being different from an order of having received the gray-level reference voltages to the source driver.

Also, a preferable mode is one wherein the supply power monitoring circuit is configured to output the control information when judging that a logic voltage is being applied to the source driver.

Also, a preferable mode is one that wherein includes a driving time detecting circuit to detect elapsed time after the start of operations of the LCD device and to output control information only at the time of driving the LCD device and wherein the output switching control section is configured not to change, at the starting time of operations of the LCD device, an order of outputting a gray-level reference voltage fed from the output voltage setting unit and to output, at the driving time of the crystal display device, according to the control information, the gray-level reference voltage fed from the output voltage setting unit in an order being different from an order of having received the gray-level reference voltage to the source driver.

Also, a preferable mode is one wherein the driving time detecting circuit is configured to output the control information when judging that the LCD device is in operation based on a lapse of specified time in a state in which a logic voltage is being fed to the source driver.

Also, a preferable mode is one that wherein includes an external storage medium to store sequence data to be used by the output switching control section and, according to the sequence data stored in the external storage medium, the output switching control section is allowed to change its operations.

Also, a preferable mode is one wherein, by reading sequence data to be used by the output switching control section from the storage medium according to control information fed from the supply power monitoring circuit or control information fed from the driving time detecting circuit and by supplying the read sequence data to the switching unit control section provided in the output switching control section, the switching unit control section exerts control of the order of switching of the switching unit.

According to a third aspect of the present invention, there is provided a control method of an LCD device employing an AC driving method including:

outputting, by using an output switching control section provided in a gray-level reference voltage generating unit, a gray-level reference voltage to a source driver in an order being different from an order of having received the gray-level reference voltage from a same output voltage setting section after being sequentially switched; and

exerting control, by using the output switching control section at a time of changing an order of outputting the gray-level reference voltage during operations of the LCD device, so as to minimize a period of time during which a difference in magnitude between a positive voltage and a negative voltage relative to an optimized intermediate potential occurs in the gray-level reference voltage making up an AC driving voltage to be input to the source driver.

According to a fourth aspect of the present invention, there is provided a control method of an LCD device employing an AC driving method including:

supplying, by using an output switching control section provided between an output voltage setting section and a source driver, a gray-level reference voltage input after being sequentially switched to the source driver in an order being different from an order of having received the gray-level reference voltage; and

minimizing, at a time of changing an order of outputting the gray-level reference voltage during operations of the LCD device, a period of time during which a difference in magnitude between a positive voltage and a negative voltage relative to an optimized intermediate potential occurs in the gray-level reference voltage making up an AC driving voltage to be input to the source driver.

In the foregoing third and fourth aspects, a preferable mode is one wherein the output switching control section includes a switching unit control section to exert control so that the gray-level reference voltage is output in a specified sequence in an order being different from an order in which the gray-level reference voltage has been input and a switching unit to make a gray-level reference voltage fed from the output voltage setting unit be output to the source driver according to control of the output switching control section in an order being different from an order in which the gray-level reference voltage has been input.

Also, a preferable mode is one that wherein includes monitoring, by using a supply power monitoring circuit, a state of supply power to be fed to the LCD device and outputting control information when the LCD device has been driven and;

configuring the output switching control section so as not to change, at a starting time of operations of the LCD device, an order of outputting a gray-level reference voltage fed from the output voltage setting unit and to output, at a driving time of the crystal display device, according to the control information, the gray-level reference voltage fed from the output voltage setting unit in an order being different from an order of having received the gray-level reference voltage to the source driver.

Also, a preferable mode is one wherein the supply power monitoring circuit is configured to output the control information when judging that a logic voltage is being applied to the source driver.

Also, a preferable mode is one that wherein includes

detecting, by using a driving time detecting circuit, elapsed time after the start of operations of the LCD device and to output control information only at the time of driving the LCD device; and

configuring the output switching control section not to change, at the starting time of operations of the LCD device, an order of outputting a gray-level reference voltage fed from the output voltage setting unit and to output, at the driving time of the crystal display device, according to the control information, the gray-level reference voltage fed from the output voltage setting unit in an order being different from an order of having received the gray-level reference voltages to the source driver.

Also, a preferable mode is one wherein the driving time detecting circuit is configured to output the control information when judging that the LCD device is in operation based on a lapse of specified time in a state in which a logic voltage is being fed to the source driver.

Also, a preferable mode is one that wherein includes storing, by using an external storage medium, sequence data to be used by the output switching control section and, according to the sequence data stored in the external storage medium, the output switching control section is allowed to change its operations.

Furthermore, a preferable mode is one wherein, by reading the sequence data to be used by the output switching control section from the storage medium according to control information fed from the supply power monitoring circuit or control information fed from the driving time detecting circuit and by supplying the read sequence data to the switching unit control section provided in the output switching control section, the switching unit control section exerts control of the order of switching of the switching unit.

With the above configurations, in the LCD device employing the AC driving method, the change of the sequence of outputting the gray-level reference voltages to its optimum order of outputting is made after the generation of gray-level reference voltages by the sequential switching method and, therefore, when an AC driving voltage is changed during operations of the LCD device, the period of time during which a difference in magnitude between a positive voltage and a negative voltage relative to the optimized intermediate potential (Vcom) occurs in the gray-level reference voltage making up the AC driving voltage can be minimized, thereby suppressing the occurrence of display abnormality such as an afterimage, flicker, luminance change, or a like.

### BRIEF DESCRIPTION OF THE DRAWINGS

The above and other objects, advantages, and features of the present invention will be more apparent from the following description taken in conjunction with the accompanying drawings in which:

FIG. 1 is a block diagram showing an entire configuration of an LCD device according to a first embodiment of the present invention;

FIG. 2 is a diagram showing a concrete configuration of a gray-level reference voltage generating section in the LCD device of FIG. 1;

FIG. 3 is a timing chart showing changes of a gray-level reference voltage of the LCD device of FIG. 1;

FIG. 4 is a block diagram showing an entire configuration of an LCD device according to a second embodiment of the present invention;

FIG. 5 is a block diagram showing an entire configuration of an LCD device according to a third embodiment of the present invention;

FIG. 6 is a block diagram showing an entire configuration of an LCD device according to a fourth embodiment of the present invention;

FIG. 7 is a block diagram showing concrete configurations of a gray-level reference voltage generating section in the LCD device of a fifth embodiment of the present invention;

FIG. 8 is a diagram showing basic configurations of a conventional LCD device;

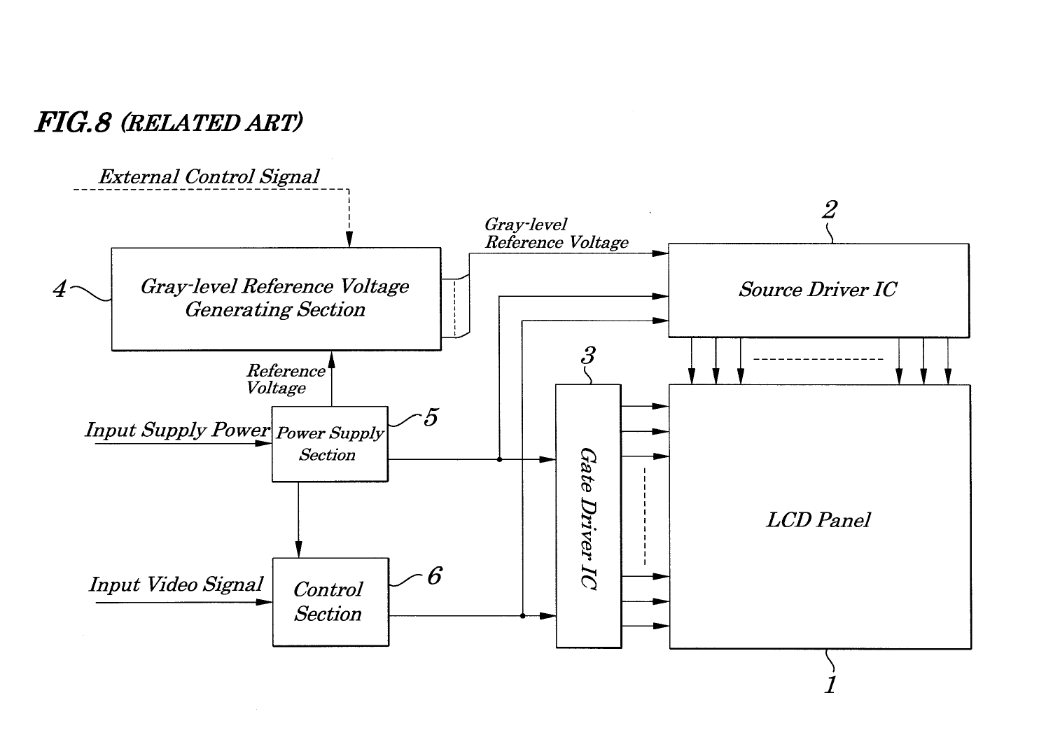

FIG. 9 is a diagram showing one example of configurations of circuits to be used when all outputs of gray-level reference voltages are generated by using each of different D/A converters;

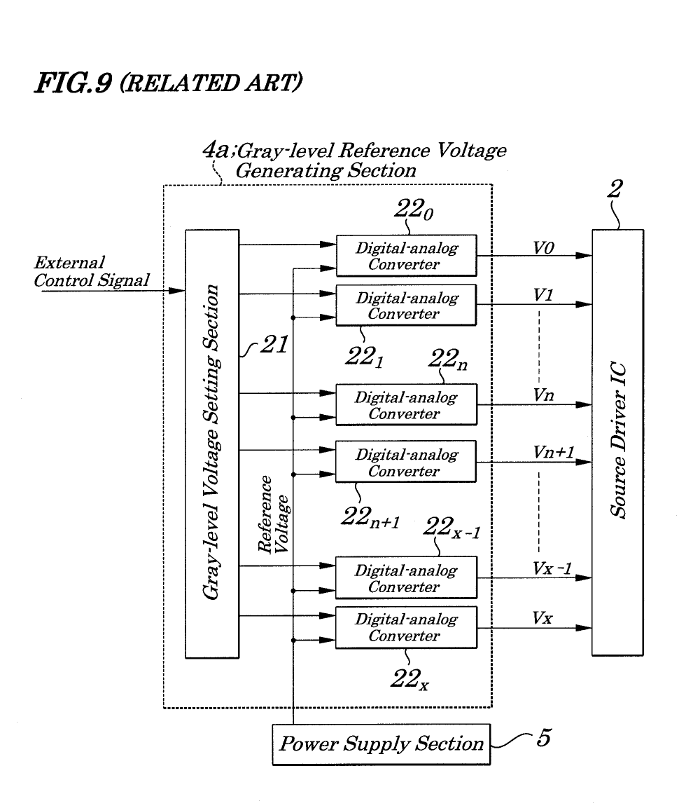

FIG. 10 is a diagram showing one example of configurations of circuits to be used when a plurality of gray-level reference voltages is generated by sequentially switching voltage outputs one by one by using the same circuit and

FIG. 11 is a timing chart explaining changes of gray-level reference voltages applied when a plurality of gray-level reference voltages is generated by sequentially switching voltage outputs one by one by using the same circuit.

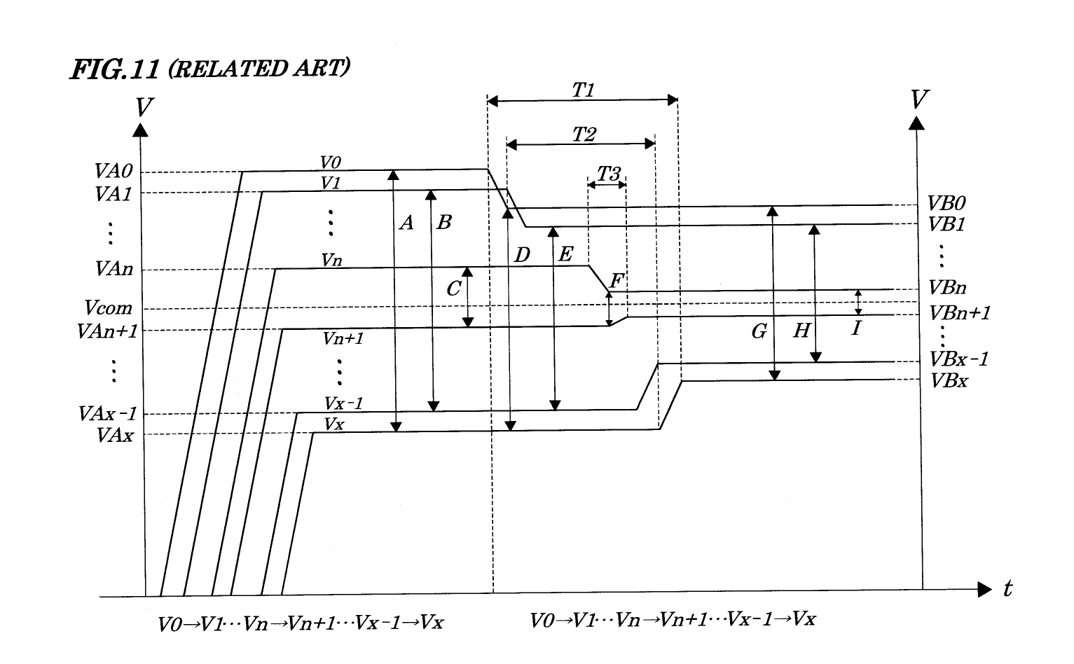

### DETAILED DESCRIPTION OF THE PREFERRED EMBODIMENTS

Best modes of carrying out the present invention will be described in further detail using various embodiments with reference to the accompanying drawings. In the AC-driving-method type LCD device of the present invention, a gray-level reference voltage generating section is provided which has an output switching control section to supply a gray-level reference voltage to a source driver in an outputting order being different from the order in which the gray-level reference voltages have been sequentially input from the same output voltage setting section after being sequentially switched and to exerts control so as to minimize, when the gray-level reference voltage making up the AC driving voltage to be input to the source driver is changed during operations of the LCD device, a period of time during which a difference in magnitude between the positive voltage and negative voltage relative to the optimized intermediate voltage occurs in the gray-level reference voltages making up the AC driving voltage to be input to the source driver.

### First Embodiment

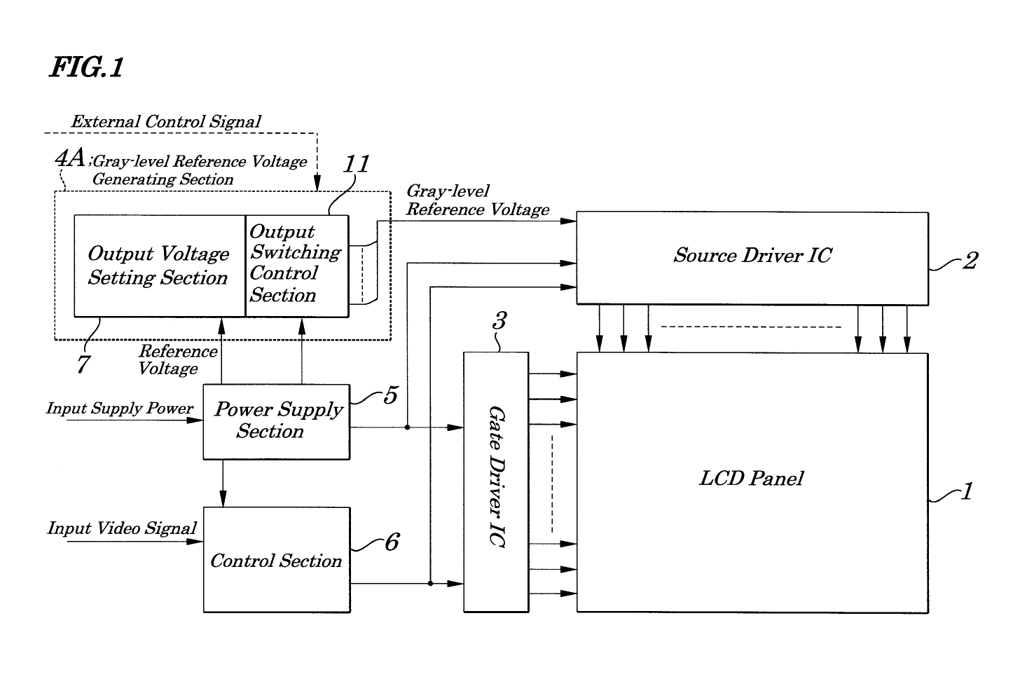

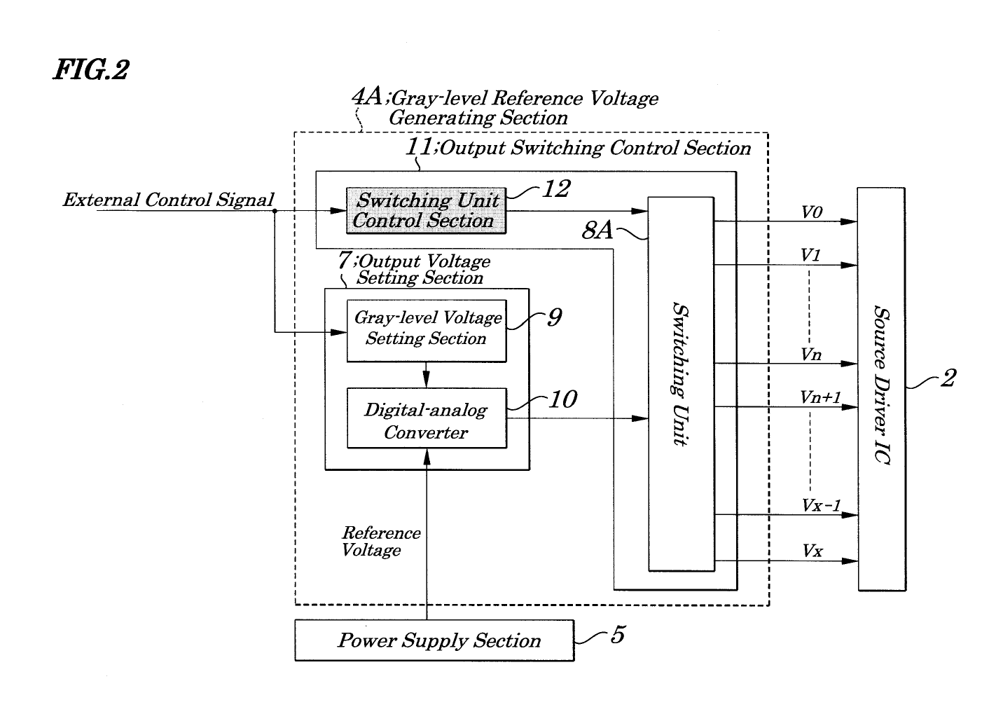

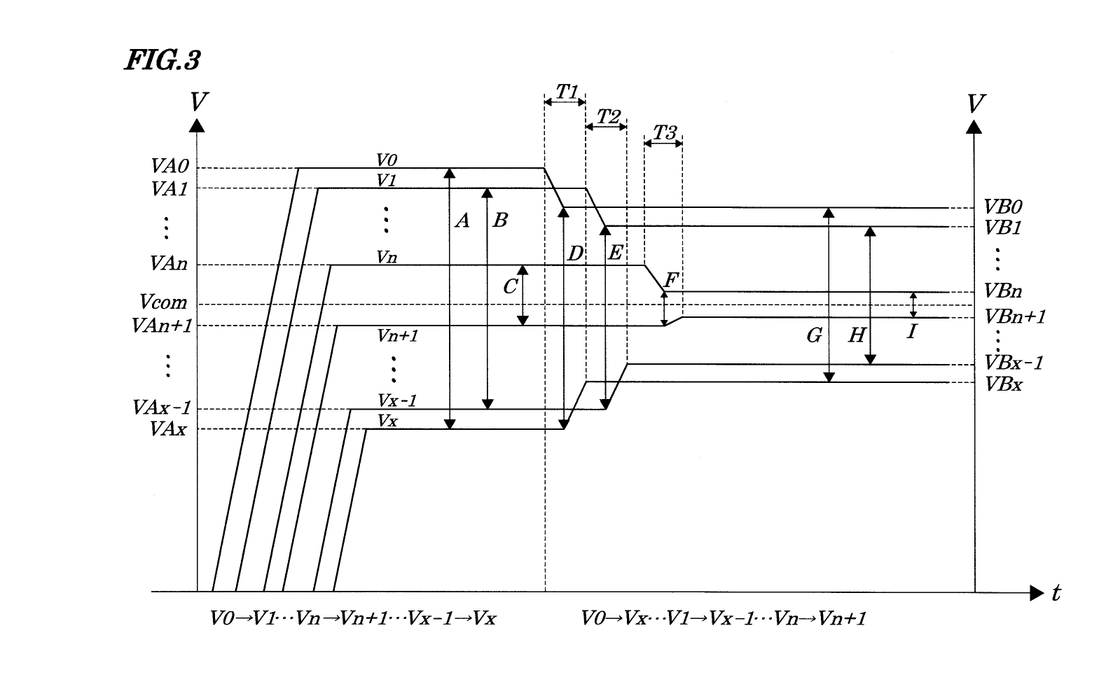

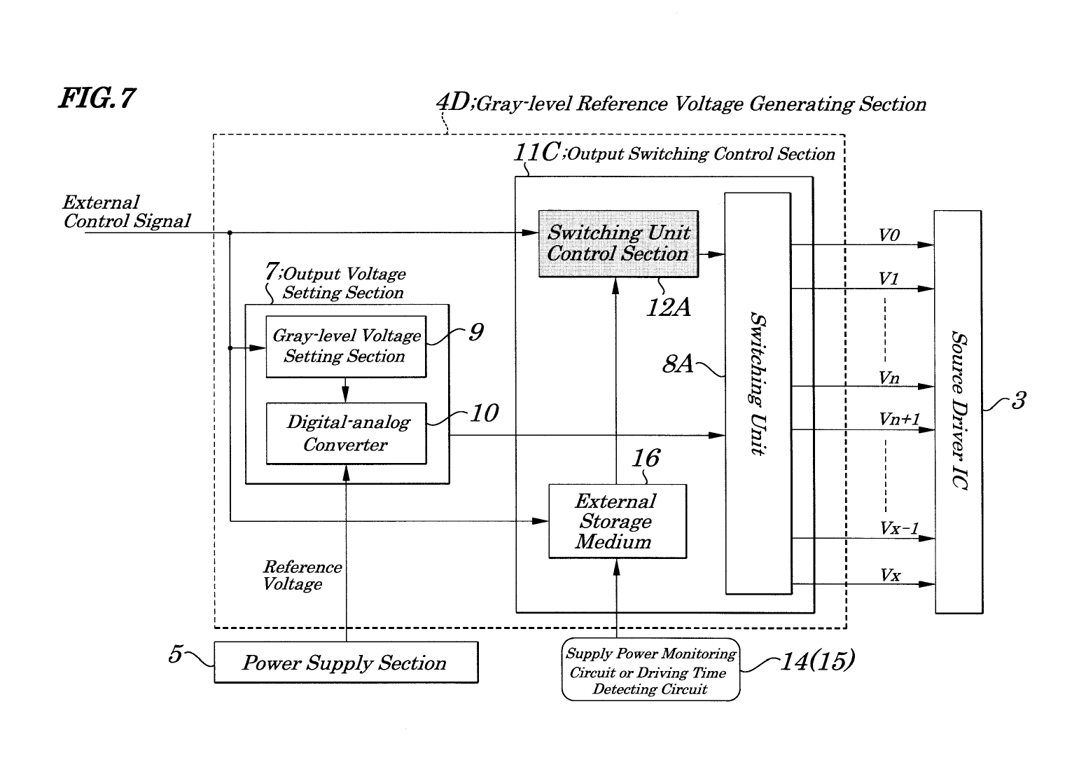

FIG. 1 is a block diagram showing an entire configuration of an LCD device according to a first embodiment of the present invention. FIG. 2 is a diagram showing a concrete configuration of a gray-level reference voltage generating section in the LCD device of FIG. 1. FIG. 3 is a timing chart explaining changes of a gray-level reference voltage of the LCD device of FIG. 1. The LCD device of the first embodiment chiefly includes, as shown in FIG. 1, an LCD panel 1, a source driver IC 2, a gate driver IC 3, a gray-level reference voltage generating section 4A, a power supply section 5, and a control section 6. Out of these, the configurations of the LCD panel 1, source driver IC 2, gate driver IC 3, power supply section 5, and control section 6 are the same as those of the conventional LCD device shown in FIG. 7 and their detailed descriptions are omitted accordingly.

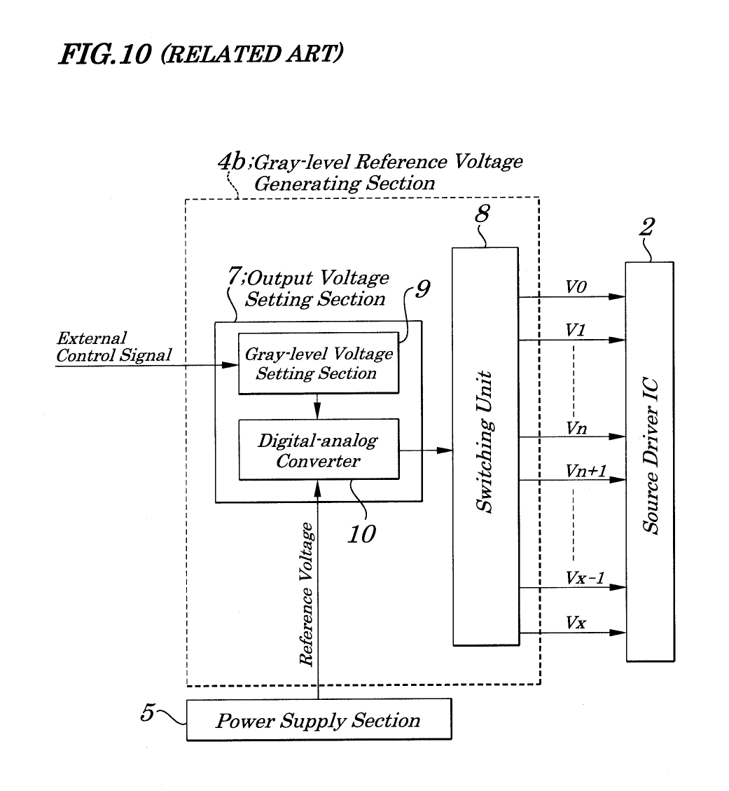

FIG. 2 shows a concrete configuration of the gray-level reference voltage generating section 4A of the LCD device of the first embodiment. The gray-level reference voltage generating section 4A is made up of an output voltage setting section 7 and an output switching control section 11 and is configured to generate a gray-level reference voltage according to external control signals and then output the generated voltage to the source driver IC 2. The configurations of the output voltage setting section 7 are the same as those shown in FIG. 10. The output voltage setting section 7 operates according to external control signals and sequentially sets gray-level reference voltages V₀, V₁, . . . , Vₙ, Vₙ₊₁, . . . , Vₓ₋₁, Vₓ to be output to each pixel on pixel strings in the source driver IC 2.

The output switching control section 11 includes a switching unit 8A and a switching unit control section 12. The switching unit control section 12 operates according to external control signals and controls switching order of the switching unit 8A on a specified sequence. The output voltage setting section 7 includes a gray-level voltage setting section 9 and a digital-analog converter 10. The switching unit 8A is configured to change the order of outputting gray-level reference voltages output from the digital-analog converter 10 of the output voltage setting section 7 to the order controlled by the switching unit control section 12 and output the voltage in the switched order.

FIG. 3 is a timing chart explaining operations of the gray-level reference voltage generating section 4A shown in FIG. 2. The control section 6 shown in FIG. 1 outputs set data to be written in each pixel of pixel strings according to input video signals. The source driver IC 2 outputs a drain voltage generated from a gray-level reference voltage based on set data to each pixel driving transistor through a corresponding data line.

With configuration shown in FIG. 2, the switching unit 8A changes, under the control of the switching unit control section 12, the order of outputting the gray-level reference voltages V₀→V₁, . . . , Vₙ→Vₙ₊₁, . . . , Vₓ₋₁→Vₓ to be sequentially output from the output voltage setting section 7, on a specified sequence and outputs the gray-level reference voltages in the changed order. By this operation, the order of having received the gray-level reference voltages to the source driver IC 2 is changed to the order being, for example, V₀→Vₓ, . . . , V₁→Vₓ₋₁, Vₙ→Vₙ₊₁.

When each of the gray-level reference voltages is changed from VA₀ to VB₀, from VA₁ to VB₁, VAₙ to VBₙ, from VAₙ₊₁ to VBₙ₊₁, from VAₓ₋₁ to VAₓ₋₁ to VBₓ₋₁, presuming that an AC driving voltage made up of VA₀ and VAₓ is referred to a voltage “A” and an AC voltage driving voltage made up of VB₀ and VBₓ is referred to a voltage “G”, during the period “T1” from a time when transition from VA₀ to VB₀ starts to a time when transition from VAₓ to VBₓ ends, an AC driving voltage “D” made up of VB₀ and VAₓ is applied to the source driver IC 2. Also, when an AC driving voltage made up of VA₁ and VAₓ₋₁ is referred to as a voltage “B” and an AC driving voltage made up of VB₁ and VBₓ₋₁ is referred to as a voltage “H”, during the period “T2” from the time when transition from VA₁ to VB₁ to the time starts to the time when transition from VAₓ₋₁ to VBₓ₋₁ ends, an AC driving voltage “E” made up of VB₁ and VAₓ₋₁ is applied to the source driver IC 2. Similarly, when an AC driving voltage made up of VAₙ and VAₙ₊₁ is referred to as a voltage “C” and an AC driving voltage made up of VBₙ and VBₙ₊₁ is referred to as a voltage “I”, during the period “T3” from the time when transition from VAₙ to VBₙ starts to the time when transition from VAₙ₊₁ to VBₙ₊₁ ends, an AC driving voltage “F” made up of VBₙ and VAₙ₊₁ is applied to the source driver IC 2.

In the LCD device shown in FIG. 1, as shown in FIG. 3, when a state in which the AC driving voltages “A”, “B”, and “C” are output is changed to be a state in which the AC driving voltages “G”, “H”, and “I”, by changing the order of outputting the gray-level reference voltages sequentially input from the same output voltage setting section 7, it is made possible to minimize the periods of time “T1”, “T2”, and “T3” during which non-uniformity in magnitude of the gray-level reference voltages making up the AC driving voltage occurs relative to an intermediate voltage (Vcom). Thus, according to the LCD device shown in FIG. 1, the period of time during which a voltage being non-uniform relative to an optimized intermediate potential (Vcom) is applied can be minimized and, therefore, the occurrence of an afterimage, flicker phenomenon, luminance change phenomenon, or a like, or the degradation of display quality can be suppressed.

### Second Embodiment

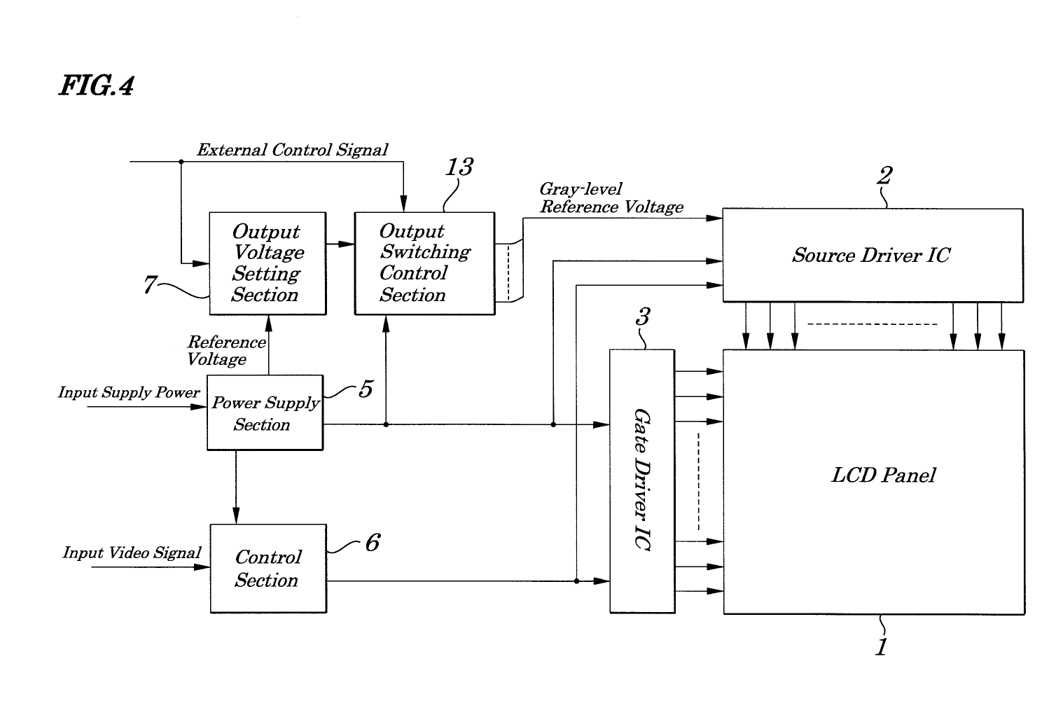

FIG. 4 is a block diagram showing an entire configuration of an LCD device according to a second embodiment of the present invention. The LCD device of the second embodiment chiefly includes, as shown in FIG. 4, an LCD panel 1, a source driver IC 2, a gate driver IC 3, a power supply section 5, a control section 6, an output voltage setting section 7, and an output switching control section 13. Out of these, configurations of the LCD panel 1, source driver IC 2, gate driver IC 3, power supply section 5, control section 6, and output voltage setting section 7 are the same as those shown in FIG. 1.

The output switching control section 13 is provided between the output voltage setting section 7 and the source driver IC 2 and, though not shown, has a switching unit control section and a switching unit. The output switching control section 13 is also configured to operate by supply power for operations fed from the power supply section 5 and to change the order of outputting the gray-level reference voltages V₀→V₁, . . . , Vₙ→Vₙ₊₁, . . . , Vₓ₋₁→Vₓ sequentially input from the output voltage setting section 7 and to be output to the source driver on a specified sequence and, therefore, to be able to change the order of outputting the gray-level reference voltage input from the output voltage setting section 7 to be output to the source driver IC 2 from the above order being V₀→V₁, . . . , Vₙ→Vₙ₊₁, . . . , Vₓ₋₁→Vₓ to the order being, for example, V₀→Vₓ, . . . , V₁→Vₓ₋₁, Vₙ→Vₙ₊₁, or a like.

According to the LCD device shown in FIG. 4, as in the case of the first embodiment, when a state of outputting of the AC driving voltage is changed, by changing the order of outputting the AC driving voltage sequentially input from the same output voltage setting section 7, the period of time during which non-uniformity occurs in magnitude of the gray-level reference voltages making up the AC driving voltage relative to an intermediate potential (Vcom) can be minimized. Thus, according to the LCD device shown in FIG. 4, the period of time during which a voltage being non-uniform relative to the optimized intermediate potential (Vcom) is applied can be minimized and, therefore, the occurrence of an afterimage, flicker phenomena, luminance change phenomenon, or a like, or the degradation of display quality can be suppressed.

### Third Embodiment

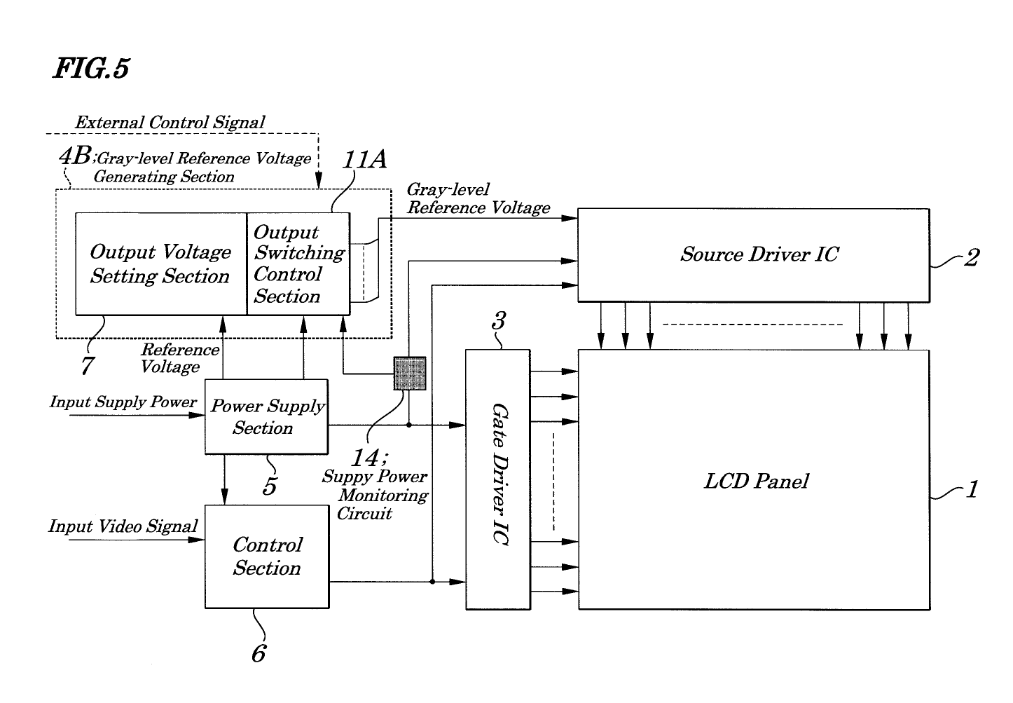

FIG. 5 is a block diagram showing an entire configuration of an LCD device according to a third embodiment of the present invention. The LCD device of the third embodiment chiefly includes an LCD panel 1, a source driver IC 2, a gate driver IC 3, a gray-level reference voltage generating section 4B, a power supply section 5, a control section 6, and a power supply voltage monitoring circuit 14. Out of these, configurations of the LCD panel 1, source driver IC 2, gate driver IC 3, power supply section 5, and control section 6 are the same as those shown in FIG. 1.

The gray-level reference voltage generating section 4B is made up of an output voltage setting section 7 and an output switching control section 11A. Out of these, configurations of the output voltage setting section 7 are the same as those in FIG. 1. The output switching control section 11A is so configured as to operate on a sequence on which the order of outputting gray-level reference voltages is switched based on states of supply power voltages to be applied at the starting times of operations of the LCD device and to be applied at the driving times of operations in a manner to correspond to change in supply power voltage to be applied to the gate driver IC 3.

The output switching control section 11A is configured to operate, according to control of the supply power monitoring circuit 14, on either a sequence to be applied at the starting time of operations of the LCD device during which the order of outputting gray-level reference voltage is not changed or on a sequence of the present invention to be applied at the driving time of the device during which the time when a difference is made large in magnitude of the gray-level reference voltages making up an AC driving voltage relative to an intermediate voltage (Vcom) at the time of changing the order of outputting the gray-level reference voltages is minimized. Here, the “starting time of operations of the device” denotes a state in which displaying is going to be started directly after the application of input supply power to the LCD device (and in which neither a drain voltage nor a gate voltage is fed from the power supply section to each pixel driving transistor, while the “driving time of the device” denotes a state in which displaying by the LCD device is being continued (and in which a logic voltage is being fed from the power supply section to the source driver IC and both the drain voltage and gate voltage are being fed to each pixel driving transistor). A precondition for operations of the supply power monitoring circuit 14 is that the logic voltage has already been applied to the source driver IC. The supply power monitoring circuit 14 judges whether the logic voltage has been turned ON or OFF and, if the logic voltage has not been placed yet, does not output control information to the output switching control section 11A and, therefore, the gray-level reference voltage output from the output switching control section 11A is fed on the sequence to be applied at the starting time of operations of the device when the order of outputting is not changed. On the other hand, the supply power monitoring circuit 14 outputs control information to the output switching control section if the logic voltage has been placed and, therefore, the gray-level reference voltage output from the output switching control section 11A is fed on the sequence to be applied at the driving time of the LCD device when the order of outputting is changed.

Moreover, by changing the setting, the output switching control section in the output switching control section 13 shown in FIG. 4 can be configured to operate, as in the case in FIG. 5, on a sequence on which the order of outputting the gray-level reference voltage sequentially generated by the output voltage setting section 7 is changed or not changed according to control information fed from the supply power monitoring circuit 14.

According to the LCD device of the third embodiment in FIG. 5, when the order of outputting gray-level reference voltages is not changed at the starting time of operations of the LCD device and the order of outputting the gray-level reference voltages is changed at the driving time of the LCD device according to information of results from monitoring supply voltages, the period of time during which a voltage being nonuniform relative to an optimized intermediate potential (Vcom) is applied can be minimized by changing the order of outputting the gray-level reference voltages sequentially input from the same output voltage setting section and, therefore, the occurrence of an afterimage, flicker, luminance change, or a like can be prevented, or the degradation of display quality can be suppressed.

### Fourth Embodiment

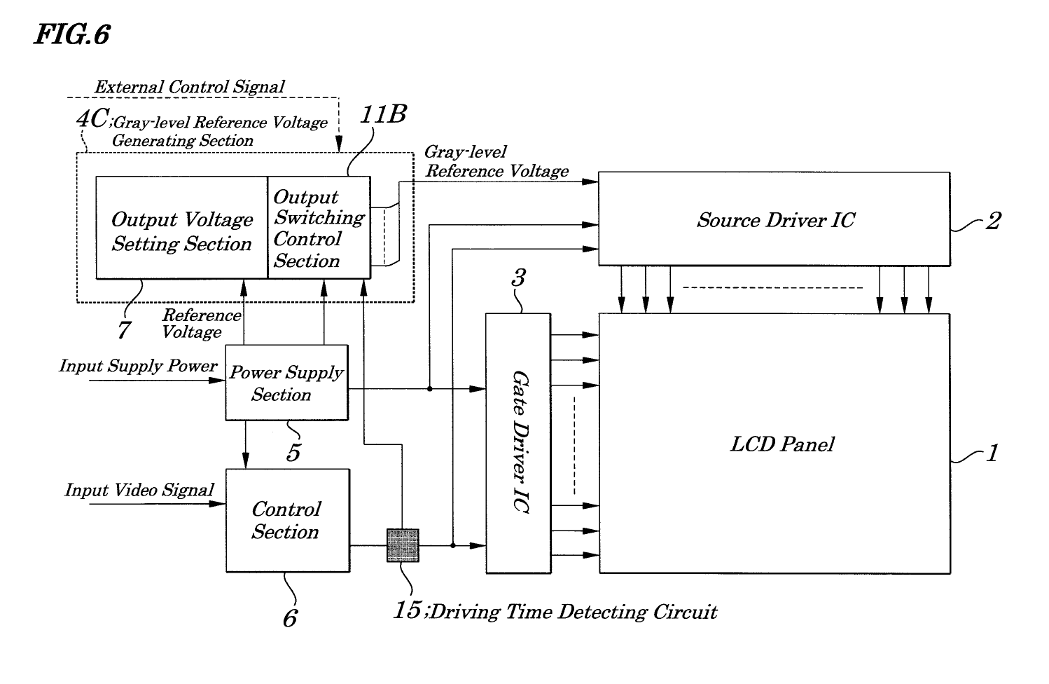

FIG. 6 is a block diagram showing an entire configuration of an LCD device according to a fourth embodiment of the present invention. The LCD device of the fourth embodiment, as shown in FIG. 6, chiefly includes an LCD panel 1, a source driver IC 2, a gate driver IC 3, a gray-level reference voltage generating section 4C, a power supply section 5, a control section 6, and a driving time detecting circuit 15. Out of these, the LCD panel 1, the source driver IC 2, the gate driver IC 3, the power supply section 5, and the control section 6 are the same as shown in FIG. 1.

The gray-level reference voltage generating section 4C is made up of an output voltage setting section 7 and an output switching control section 11B. Out of these, the output voltage setting section 7 is the same as shown in FIG. 1. The output switching control section 11B is so configured to operate on a sequence on which the order of outputting gray-level reference voltages is switched based on states of device supply power that changes with elapsed time after the start of operations of the LCD device in a manner to correspond to change in supply power to be applied to the gate driver IC 3.

The output switching control section 11B is configured to operate, according to control of the driving time detecting circuit 15, on either a sequence to be applied at the starting time of operations of the LCD device during which the order of outputting gray-level reference voltages is not changed or on a sequence of the present invention to be applied at the driving time of the device when the period of time during which a difference is made large in magnitude of the gray-level reference voltages relative to an intermediate voltage (Vcom) at the time of making up an AC driving voltage at the time of changing the order of outputting the gray-level reference voltages is minimized. Here, the states of the “starting time of operations of the device” and of the “driving time of the device” are the same as those described when the operation of the output switching control section 11A in FIG. 5 was explained. A precondition for operations of the driving time detecting circuit 15 is that the logic voltage has already been placed. The driving time detecting circuit 15 judges whether the logic voltage has been turned ON or OFF and, if the logic voltage has not been placed, does not output control information to the output switching control section 11B and, therefore, the gray-level reference voltage output from the output switching control section 11B is fed on the sequence to be applied at the starting time of operations of the LCD device when the order of outputting is not changed. On the other hand, the driving time detecting circuit 15 outputs control information to the output switching control section 11B if the logic voltage has been placed and, therefore, the gray-level reference voltage output from the output switching control section 11B is fed on the sequence to be applied at the driving time of the LCD device when the order of outputting is changed. However, for the time period required for changing the order of outputting video signals to the source driver IC 2 which are input after the LCD device is powered on before displaying is started or for the idle time period required for the stabilization of clock synchronization, no displaying occurs even if a logic voltage is placed and, therefore, these time periods are not considered as “the period of time during which the LCD device is in operation”.

Moreover, a switching unit control section in an output switching control section 13 shown in FIG. 4, as in the case in FIG. 6, is also allowed to operate on a sequence of changing, according to control information fed from the driving time detecting circuit 15, the order of gray-level reference voltage sequentially generated by the output voltage setting section 7 or on a sequence of not changing the gray-level reference voltage.

According to the LCD device of the fourth embodiment in FIG. 6, when the order of outputting the gray-level reference voltage is not changed at the starting time of the LCD device and the state of outputting the AC driving voltage is changed after the LCD device is in a driving state according to information obtained during elapsed time after the start of its operations, by changing the order of outputting the gray-level reference voltage sequentially input from the same output voltage setting section 7, the period of time during which a voltage being non-uniform relative to the optimized intermediate potential (Vcom) is applied can be minimized, thus suppressing an occurrence of an afterimage, flicker, luminance change, or a like, or a degradation of display quality.

### Fifth Embodiment

FIG. 7 is a block diagram showing concrete configurations of a gray-level reference voltage generating section in the LCD device of a fifth embodiment of the present invention. The gray-level reference voltage generating section 4D of the fifth embodiment, as shown in FIG. 7, includes an output voltage setting section 7 and an output switching control section 11C. Out of these, configurations of the output voltage setting section 7 are the same as shown in FIG. 2. The output switching control section 11C is made up of a switching unit 8A, switching unit control section 12A, and an external storage medium 16. Out of these, configurations of the switching unit 8A are the same as those shown in FIG. 2.

The switching unit control section 12A controls the order of switching the switching unit 8A on a sequence read from the external storage medium 16 according to external control signals. The external storage medium 16 is configured to output sequence data to change the order of outputting gray-level reference voltages in the switching unit 8A according to information of a result from monitoring of supply power fed from the supply power monitoring circuit 14 or not to change the above order.

As a result, the switching unit 8A does not change the order of outputting gray-level reference voltages fed from the output voltage setting section 7 on a sequence to be applied at the driving time of the device while the AC driving voltage is applied at the driving time of the device and, in the driving state of the LCD device, according to information of a result from monitoring the supply voltage or to information obtained during elapsed time after the start of operations of the LCD device, the order of outputting the gray-level reference voltage fed from the output voltage setting section 7 is changed according to a sequence on which the order of outputting the gray-level reference voltage at the time of application of the AC driving voltage is changed.

Moreover, the switching unit in the output switching control section 13 shown in FIG. 4, as in the case in FIG. 7, is also allowed to set the order of outputting gray-level reference voltages sequentially input from the output voltage setting section 7 on a sequence set by the external storage medium 16 according to changes in device supply power at the starting time of operations fed from the supply power monitoring circuit 15 or according to information obtained during elapsed time after driving of the device fed from the driving time detecting circuit 15.

According to the LCD device of the fifth embodiment shown in FIG. 7, the output switching control section 11A (FIG. 5) or the output switching control section 11B (FIG. 6), even if sequence data on changing the order of outputting the gray-level reference voltage is not set thereto, decides not to change the order of outputting the gray-level voltage, according to information of results from monitoring the supply power being fed or according to information obtained during elapsed time after operations of the LCD device is started, or decides to change, when the state of outputting the AC driving voltage is changed after the LCD device is in a driving state, the order of outputting the gray-level reference voltage sequentially input from the same output voltage setting section 7 and, as a result, the period of time during which a voltage being non-uniform relative to the optimized intermediate potential (Vcom) is applied can be minimized, thus suppressing the occurrence of an afterimage, flicker, luminance change, or a like, or the degradation of display quality.

It is apparent that the present invention is not limited to the above embodiments but may be changed and modified without departing from the scope and spirit of the invention. For example, the driving method of the LCD panel in the LCD device is not limited to the AC driving method in which the polarity of voltages for an entire frame in one frame period is inverted and may includes a line-inversion AC driving method in which a polarity is alternately inverted in every one line in a screen and the polarity of each line is alternately inverted in every one frame and a dot-inversion AC driving method in which a polarity is inverted in every dot (pixel) in a screen and the polarity of each dot is alternately inverted in every frame period.

Furthermore, the LCD device and method of driving the LCD device can be used to suppress the occurrence of an afterimage, flicker, luminance change, or a like, and to prevent the degradation of display quality in the LCD section of such as a liquid crystal television set, personal computer, car navigation system, personal digital assistant (PDA), or a like.

What is claimed is:

1. A liquid crystal display device employing an AC driving method comprising:
an output switching control section provided in a gray-level reference voltage generating unit to output a gray-level reference voltage to a source driver in an order being different from an order of having received said gray-level reference voltage from a same output voltage setting section after being sequentially switched, wherein said output switching control section exerts control, at a time of changing an order of outputting said gray-level reference voltage during operations of said liquid crystal display device, so as to minimize a period of time during which a difference in magnitude between a positive voltage and a negative voltage relative to an optimized intermediate potential occurs in said gray-level reference voltage making up an AC driving voltage to be input to said source driver.

2. The liquid crystal display device according to claim 1, wherein said output switching control section comprises a switching unit control section to control so that said gray-level reference voltage is output in a specified sequence in an order being different from an order in which said gray-level reference voltage has been input and a switching unit to make a gray-level reference voltage fed from said output voltage setting unit be output to said source driver according to control of said output switching control section in an order being different from an order in which said gray-level reference voltage has been input.

3. The liquid crystal display device according to claim 1, further comprising a supply power monitoring circuit to monitor a state of supply power to be fed to said liquid crystal display device and to output control information when said liquid crystal display device is driven and wherein said output switching control section is configured not to change, at a starting time of operations of said liquid crystal display device, an order of outputting a gray-level reference voltage fed from said output voltage setting unit and to output, at a driving time of said liquid crystal display device, according to said control information, said gray-level reference voltage fed from said output voltage setting unit in an order being different from an order of having received the gray-level reference voltages to said source driver.

4. The liquid crystal display device according to claim 3, wherein said supply power monitoring circuit is configured to output said control information when judging that a logic voltage is being applied to said source driver.

5. The liquid crystal display device according to claim 1, further comprising a driving time detecting circuit to detect elapsed time after the start of operations of the liquid crystal display device and to output control information only at the time of driving said liquid crystal display device and wherein said output switching control section is configured not to change, at the starting time of operations of said liquid crystal display device, an order of outputting a gray-level reference voltage fed from said output voltage setting unit and to output, at the driving time of said crystal display device, according to said control information, said gray-level reference voltage fed from said output voltage setting unit in an order being different from an order of having received said gray-level reference voltage to said source driver.

6. The liquid crystal display device according to claim 5, wherein said driving time detecting circuit is configured to output said control information when judging that said liquid crystal display device is in operation based on a lapse of specified time in a state in which a logic voltage is being fed to said source driver.

7. The liquid crystal display device according to claim 3, still further comprising an external storage medium to store sequence data to be used by said output switching control section and, according to said sequence data stored in said external storage medium, said output switching control section is allowed to change its operations.

8. The liquid crystal display device according to claim 3, wherein, by reading sequence data to be used by said output switching control section from said storage medium according to control information fed from said supply power monitoring circuit or control information fed from said driving time detecting circuit and by supplying the read sequence data to said switching unit control section provided in said output switching control section, said switching unit control section exerts control of the order of switching by using said switching unit.

9. A liquid crystal display device employing an AC driving method comprising:
an output switching control section provided between an output voltage setting section and a source driver, wherein said output switching control section exerts control so as to supply a gray-level reference voltage input after being sequentially switched to a source driver in an order being different from an order of having received said gray-level reference voltage and so as to minimize, at a time of changing an order of outputting said gray-level reference voltage during operations of said liquid crystal display device, a period of time during which a difference in magnitude between a positive voltage and a negative voltage relative to an optimized intermediate potential occurs in said gray-level reference voltage making up an AC driving voltage to be input to said source driver.

10. The liquid crystal display device according to claim 9, wherein said output switching control section comprises a switching unit control section to exert control so that said gray-level reference voltage is output in a specified sequence in an order being different from an order in which said gray-level reference voltage has been input and a switching unit to make a gray-level reference voltage fed from said output voltage setting unit be output to said source driver according to control of said output switching control section in an order being different from an order in which said gray-level reference voltage has been input.

11. The liquid crystal display device according to claim 9, further comprising a supply power monitoring circuit to monitor a state of supply power to be fed to said liquid crystal display device and to output control information when said liquid crystal display device is driven and wherein said output switching control section is configured not to change, at a starting time of operations of said liquid crystal display device, an order of outputting a gray-level reference voltage fed from said output voltage setting unit and to output, at a driving time of said liquid crystal display device, according to said control information, said gray-level reference voltage fed from said output voltage setting unit in an order being different from an order of having received the gray-level reference voltages to a source driver.

12. The liquid crystal display device according to claim 11, wherein said supply power monitoring circuit is configured to output said control information when judging that a logic voltage is being applied to a source driver.

13. The liquid crystal display device according to claim 9, further comprising a driving time detecting circuit to detect elapsed time after the start of operations of the liquid crystal display device and to output control information only at the time of driving said liquid crystal display device and wherein said output switching control section is configured not to change, at the starting time of operations of said liquid crystal display device, an order of outputting a gray-level reference voltage fed from said output voltage setting unit and to output, at the driving time of said crystal display device, according to said control information, said gray-level reference voltage fed from said output voltage setting unit in an order being different from an order of having received said gray-level reference voltage to a source driver.

14. The liquid crystal display device according to claim 13, wherein said driving time detecting circuit is configured to output said control information when judging that said liquid crystal display device is in operation based on a lapse of specified time in a state in which a logic voltage is being fed to said source driver.

15. The liquid crystal display device according to claim 11, still further comprising an external storage medium to store sequence data to be used by said output switching control section and, according to said sequence data stored in said external storage medium, said output switching control section is allowed to change its operations.

16. The liquid crystal display device according to claim 11, wherein, by reading sequence data to be used by said output switching control section from said storage medium according to control information fed from said supply power monitoring circuit or control information fed from said driving time detecting circuit and by supplying the read sequence data to said switching unit control section provided in said output switching control section, said switching unit control section exerts control of the order of switching by using said switching unit.

17. A control method of a liquid crystal display device employing an AC driving method comprising:
outputting, by using an output switching control section provided in a gray-level reference voltage generating unit, a gray-level reference voltage to a source driver in an order being different from an order of having received said gray-level reference voltage from a same output voltage setting section after being sequentially switched; and
exerting control, by using said output switching control section at a time of changing an order of outputting said gray-level reference voltage during operations of said liquid crystal display device, so as to minimize a period of time during which a difference in magnitude between a positive voltage and a negative voltage relative to an optimized intermediate potential occurs in said gray-level reference voltage making up an AC driving voltage to be input to said source driver.

18. The control method of the liquid crystal display device according to claim 17, wherein said output switching control section comprises a switching unit control section to exert control so that said gray-level reference voltage is output in a specified sequence in an order being different from an order in which said gray-level reference voltage has been input and a switching unit to make a gray-level reference voltage fed from said output voltage setting unit be output to said source driver according to control of said output switching control section in an order being different from an order in which said gray-level reference voltage has been input.

19. The control method of the liquid crystal display device according to claim 17, further comprising:
monitoring, by using a supply power monitoring circuit, a state of supply power to be fed to said liquid crystal display device and outputting control information when said liquid crystal display device has been driven and;
configuring said output switching control section so as not to change, at a starting time of operations of said liquid crystal display device, an order of outputting a gray-level reference voltage fed from said output voltage setting unit and to output, at a driving time of said crystal display device, according to said control information, said gray-level reference voltage fed from said output voltage setting unit in an order being different from an order of having received said gray-level reference voltage to said source driver.

20. The control method of the liquid crystal display device according to claim 19, wherein said supply power monitoring circuit is configured to output said control information when judging that a logic voltage is being applied to a source driver.

21. The control method of the liquid crystal display device according to claim 17, still further comprising:
detecting, by using a driving time detecting circuit, elapsed time after the start of operations of said liquid crystal display device and to output control information only at the time of driving said liquid crystal display device; and
configuring said output switching control section not to change, at the starting time of operations of said liquid crystal display device, an order of outputting a gray-level reference voltage fed from said output voltage setting unit and to output, at the driving time of said crystal display device, according to said control information, said gray-level reference voltage fed from said output voltage setting unit in an order being different from an order of having received said gray-level reference voltages to said source driver.

22. The control method of the liquid crystal display device according to claim 21, wherein said driving time detecting circuit is configured to output said control information when judging that said liquid crystal display device is in operation based on a lapse of specified time in a state in which a logic voltage is being fed to said source driver.

23. The control method of the liquid crystal display device according to claim 19, still further comprising:
storing, by using an external storage medium, sequence data to be used by said output switching control section and, according to said sequence data stored in said external storage medium, said output switching control section is allowed to change its operations.

24. The control method of the liquid crystal display device according to claim 23: wherein, by reading said sequence data to be used by said output switching control section from said storage medium according to control information fed from said supply power monitoring circuit or control information fed from said driving time detecting circuit and by supplying the read sequence data to said switching unit control section provided in said output switching control section, said switching unit control section exerts control of the order of switching of said switching unit.

25. A control method of a liquid crystal display device employing an AC driving method comprising:
supplying, by using an output switching control section provided between an output voltage setting section and a source driver, a gray-level reference voltage input after being sequentially switched to a source driver in an order being different from an order of having received said gray-level reference voltage; and
minimizing, at a time of changing an order of outputting said gray-level reference voltage during operations of said liquid crystal display device, a period of time during which a difference in magnitude between a positive voltage and a negative voltage relative to an optimized intermediate potential occurs in said gray-level reference voltage making up an AC driving voltage to be input to said source driver.

26. The control method of the liquid crystal display device according to claim 25, further comprising:
controlling, by using said output switching control section with a switching unit control section, so that said gray-level reference voltage is output in a specified sequence in an order being different from an order in which said gray-level reference voltage has been input; and
making, by using a switching unit, a gray-level reference voltage fed from said output voltage setting unit be output to said source driver according to control of said output switching control section in an order being different from an order in which said gray-level reference voltage has been input.

27. The control method of the liquid crystal display device according to claim 25, further comprising:
monitoring, by using a supply power monitoring circuit, a state of supply power to be fed to said liquid crystal display device and outputting control information when said liquid crystal display device has been driven and;
configuring said output switching control section so as not to change, at a starting time of operations of said liquid crystal display device, an order of outputting a gray-level reference voltage fed from said output voltage setting unit and to output, at a driving time of said crystal display device, according to said control information, said gray-level reference voltage fed from said output voltage setting unit in an order being different from an order of having received said gray-level reference voltage to said source driver.

28. The control method of the liquid crystal display device according to claim 27, wherein said supply power monitoring circuit is configured to output said control information when judging that a logic voltage is being applied to a source driver.

29. The control method of the liquid crystal display device according to claim 25, still further comprising:
detecting, by using a driving time detecting circuit, elapsed time after the start of operations of said liquid crystal display device and to output control information only at the time of driving said liquid crystal display device; and
configuring said output switching control section not to change, at the starting time of operations of said liquid crystal display device, an order of outputting a gray-level reference voltage fed from said output voltage setting unit and to output, at the driving time of said crystal display device, according to said control information, said gray-level reference voltage fed from said output voltage setting unit in an order being different from an order of having received said gray-level reference voltages to said source driver.

30. The control method of the liquid crystal display device according to claim 29, wherein said driving time detecting circuit is configured to output said control information when judging that said liquid crystal display device is in operation based on a lapse of specified time in a state in which a logic voltage is being fed to said source driver.

31. The control method of the liquid crystal display device according to claim 27, still further comprising:
storing, by using an external storage medium, sequence data to be used by said output switching control section and, according to said sequence data stored in said external storage medium, said output switching control section is allowed to change its operations.

32. The control method of the liquid crystal display device according to claim 31: wherein, by reading said sequence data to be used by said output switching control section from said storage medium according to control information fed from said supply power monitoring circuit or control information fed from said driving time detecting circuit and by supplying the read sequence data to said switching unit control section provided in said output switching control section, said switching unit control section exerts control of the order of switching of said switching unit.
